(19) United States
(12) Patent Application Publication
(10) Pub. No.: US 2026/0324526 A1
(43) Pub. Date: Oct. 22, 2026

(54) GARDEN FORK APPARATUS

(71) Applicant: Clyde B. Singh, Pemberville, OH (US)

(72) Inventor: Clyde B. Singh, Pemberville, OH (US)

(21) Appl. No.: 19/181,018

(22) Filed: Apr. 16, 2025

(51) Int. Cl. A01B 1/10

(52) U.S. Cl. CPC A01B 1/10

(57) ABSTRACT

A garden fork apparatus for turning soil without disturbing worms includes a handle and a tool head coupled to the handle. The tool head comprises a plurality of tines which are spaced apart laterally from each other. Each tine extends between a mounting end and a tip end. Each tine also comprises a main portion and an angled portion, wherein the main portion extends from the mounting end to the angled portion of the tine and the angled portion extends from the main portion to the tip end of the tine. The main portion of each tine is elongated. The angled portion of each tine is elongated and is angled upwardly from the main portion.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to garden tools and more particularly pertains to a new garden tool for turning soil without disturbing worms.

### (2) Description of Related Art Including Information Disclosed Under 37 CFR 1.97 and 1.98

The prior art describes various garden forks. However, the prior art does not disclose a garden fork with tines sized to avoid disturbing worms in the soil, in which distal sections of the tines are bent approximately 15-degrees from axes of proximal sections of the tines, and in which tapered ends are formed on the tines with an angle of between 30 and 40 degrees between tapering surfaces.

### (h) BRIEF SUMMARY OF THE INVENTION

An embodiment of the disclosure meets the needs presented above by generally comprising a handle and a tool head coupled to the handle. The tool head comprises a plurality of tines which are spaced apart laterally from each other. Each tine extends between a mounting end and a tip end. Each tine also comprises a main portion and an angled portion, wherein the main portion extends from the mounting end to the angled portion of the tine and the angled portion extends from the main portion to the tip end of the tine. The main portion of each tine is elongated. The angled portion of each tine is elongated and is angled upwardly from the main portion.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a garden fork apparatus according to an embodiment of the disclosure.

FIG. 2 is a top view of an embodiment of the disclosure.

FIG. 3 is a side view of an embodiment of the disclosure.

FIG. 4 is a detail cross-sectional view of an embodiment of the disclosure taken from Window 4 in FIG. 3.

FIG. 5 is an in-use view of an embodiment of the disclosure.

### (j) DETAILED DESCRIPTION OF THE INVENTION

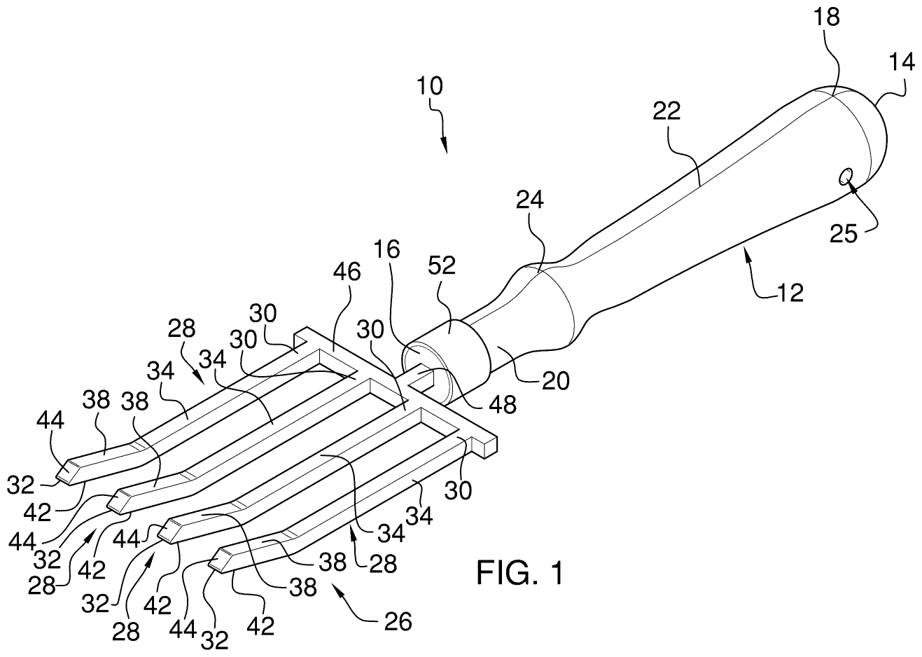

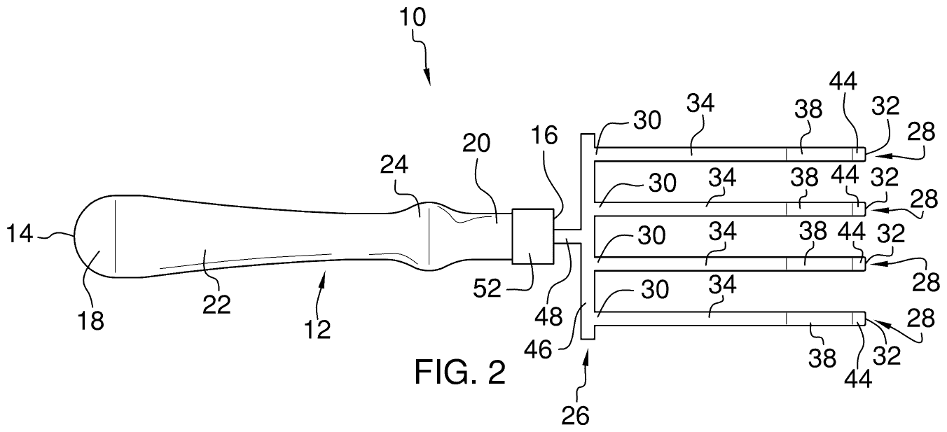

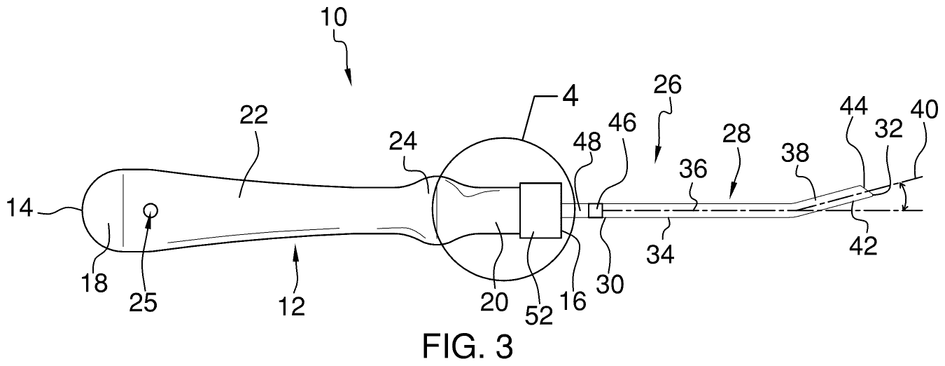

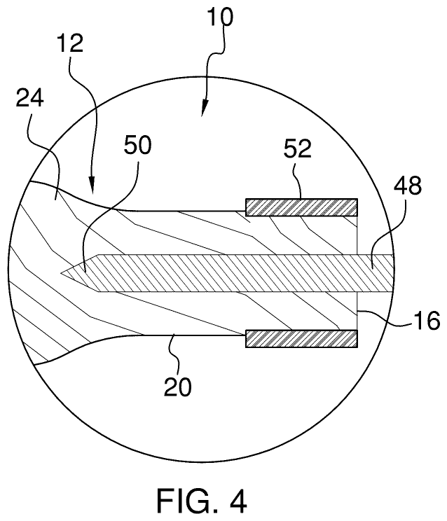

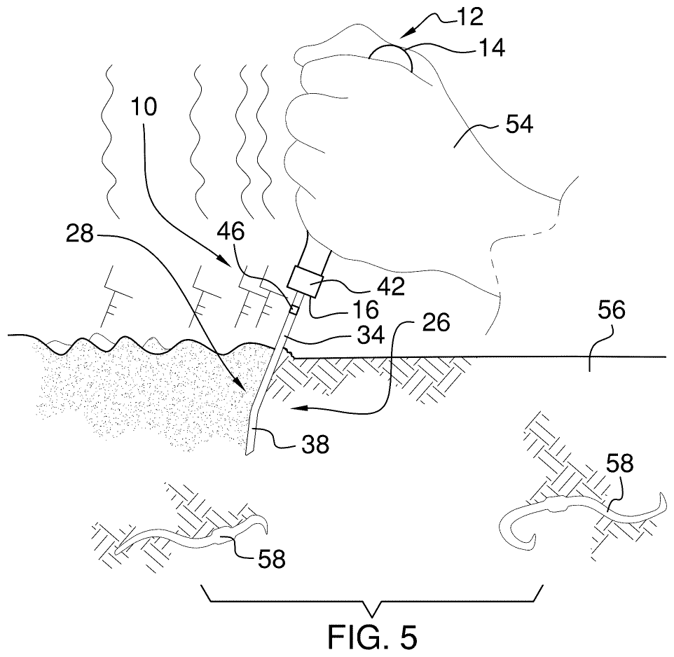

With reference now to the drawings, and in particular to FIGS. 1 through 5 thereof, a new garden tool embodying the principles and concepts of an embodiment of the disclosure and generally designated by the reference numeral 10 will be described.

As best illustrated in FIGS. 1 through 5, the garden fork apparatus 10 generally comprises a handle 12 which is elongated between a first end 14 and a second end 16. The handle 12 has a first end section 18 at the first end 14 which is rounded and a tapering section 22 which tapers from the first end section 18 toward a second end section 20 of the handle 12 at the second end 16. The handle 12 has a protrusion section 24 which is positioned between the tapering section 22 and the second end section 20. The protrusion section 24 protrudes outwardly with respect to the tapering section 22 and the second end section 20. The protrusion section 24 is positioned nearer the second end 16 of the handle 12 than the first end 14 of the handle 12. The handle 12 has a hole 25 which extends transversely through the handle 12 in the first end section 18 for receiving a cord or strap therethrough which may be used to hang the garden fork apparatus 10 from a hook or the like.

A tool head 26 is coupled to the second end 16 of the handle 12. The tool head 26 comprises a plurality of tines 28 mounted onto a crossbar 46. The tines 28 are spaced apart laterally from each other on the crossbar 46. Each tine 28 extends between a mounting end 30 at the crossbar 46 and a tip end 32 distal from the crossbar 46. Each tine 28 comprises a main portion 34 and an angled portion 38, wherein the main portion 34 extends from the mounting end 30 to the angled portion 38 and the angled portion 38 extends from the main portion 34 to the tip end 32. The main portion 34 and the angled portion 38 of each tine 28 are elongated and straight. The angled portion 38 of each tine 28 is angled upwardly from the main portion 34 such that an angle between a longitudinal axis 36 of the main portion 34 and a longitudinal axis 40 of the angled portion 38 of each tine 28 is between 10.0 degrees and 20.0 degrees. An end surface 44 at the tip end 32 and a bottom surface 42 of the angled portion 38 of each tine 28 form an angle therebetween which is between 30.0 degrees and 38.0 degrees. The tines 28 lie parallel to each other, and each tine 28 has a constant width between the mounting end 30 and the tip end 32. Each tine 28 has a length between the mounting end 30 and the tip end 32 of between 4.5 inches and 5.5 inches.

The tool head 26 further comprises a connection member 48 which is coupled to the crossbar 46 opposite the plurality of tines 28. The connection member 48 is coupled to handle 12 at the second end 16. The connection member 48 comprises an elongated body with a tapered tip portion 50 distal from the crossbar 46. The connection member 48 is received into the elongated body through the second end 16 and is coupled to the handle 12 via a friction fit. Attaching the connection member 48 to the handle 12 may be done by inserting the connection member 48 into a preformed hole in the handle 12 which is shorter than the connection member 48 such that the tapered tip portion 50 is made to pierce the handle 12 when inserted into the preformed hole, thereby frictionally engaging the handle 12 via the tapered tip portion 50. Bounding surfaces of the preformed hole also may frictionally engage with the connection member 48.

The handle 12 is wooden and may be finished with polyurethane or similar to protect the handle 12 from moisture and provide a smooth exterior for comfortable handling. The tool head 26 comprises a metal material such as steel and may also be coated with a moisture-protective barrier. A support ring 52 is coupled to the handle 12 at the second end section 20. The support ring 52 extends around and binds the handle 12 to reinforce the handle 12, thereby preventing any cracking or other damage which may be caused to the handle 12 during connection to the connection member 48 and during use. The support ring 52 is formed of a metal material which is conformable to an exterior of the handle 12.

In use, a user 54 may grasp the handle 12 and insert the tines 28 of the tool head 26 into soil 56. Then the user 54 may move the tines 28 through the soil 56 to loosen, lift, and turn over soil 56. The lengths of the tines 28 are beneficial for avoiding worms 58 in the soil 56, which typically burrow deeper than the reach of the tines 28 from above the ground.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A garden fork apparatus comprising:
a handle; and
a tool head coupled to the handle, the tool head comprising a plurality of tines, the plurality of tines being spaced apart laterally from each other, each tine of the plurality of tines extending between a mounting end and a tip end, each tine of the plurality of tines comprising a main portion and an angled portion, the main portion of each tine extending from the mounting end to the angled portion of the tine, the angled portion of each tine extending from the main portion to the tip end of the tine, the main portion of each tine being elongated, the angled portion of each tine being elongated and being angled upwardly from the main portion.

2. The garden fork apparatus of claim 1, wherein an angle between a longitudinal axis of the main portion and a longitudinal axis of the angled portion of each tine being between 10.0 degrees and 20.0 degrees.

3. The garden fork apparatus of claim 2, wherein the main portion and the angled portion of each tine are straight.

4. The garden fork apparatus of claim 1, wherein an end surface at the tip end and a bottom surface of the angled portion of each tine have an acute angle therebetween.

5. The garden fork apparatus of claim 4, wherein the angle between the end surface and the bottom surface of the angled portion is between 30.0 degrees and 40.0 degrees.

6. The garden fork apparatus of claim 1, wherein tines of the plurality of tines lie parallel to each other.

7. The garden fork apparatus of claim 1, wherein each tine of the plurality of tines has a constant width between the mounting end and the tip end.

8. The garden fork apparatus of claim 1, wherein each tine of the plurality of tines has a length between the mounting end and the tip end of between 4.5 inches and 5.5 inches.

9. The garden fork apparatus of claim 1, wherein the tool head further comprises:
a crossbar coupled to the plurality of tines, the crossbar being coupled to the mounting ends of the plurality of tines; and
a connection member coupled to the crossbar opposite the plurality of tines, the connection member comprising an elongated body with a tapered tip portion distal to the crossbar, the connection member being received into the elongated body through the second end, the connection member being coupled to the handle via a friction fit.

10. The garden fork apparatus of claim 9, further comprising a support ring coupled to the handle adjacent to the tool head, the support ring extending around and binding the handle to reinforce the handle.

11. The garden fork apparatus of claim 1, wherein the handle is elongated between a first end and a second end, the tool head being positioned on the second end of the handle.

12. The garden fork apparatus of claim 11, wherein the handle has a first end section at the first end which is rounded.

13. The garden fork apparatus of claim 11, wherein the handle has a tapering section which tapers in a direction extending from the first end toward the second end.

14. The garden fork apparatus of claim 11, wherein the handle has a protrusion section which protrudes outwardly with respect to adjacent portions of the handle on opposing sides of the protrusion, the protrusion section being positioned nearer the second end of the handle than the first end of the handle.

15. A garden fork apparatus comprising:
a handle, the handle being elongated between a first end and a second end, the handle having a first end section at the first end which is rounded, the handle having a tapering section which tapers from the first end section toward a second end section of the handle at the second end, the handle having a protrusion section which is positioned between the tapering section and the second end section, the protrusion section protruding outwardly with respect to the tapering section and the second end section, the protrusion section being positioned nearer the second end of the handle than the first end of the handle, the handle having a hole extending transversely through the handle in the first end section;
a tool head coupled to the handle, the tool head being positioned on the second end of the handle, the tool head comprising:
a plurality of tines, the plurality of tines being spaced apart laterally from each other, each tine of the plurality of tines extending between a mounting end and a tip end, each tine of the plurality of tines comprising a main portion and an angled portion, the main portion of each tine extending from the mounting end to the angled portion of the tine, the angled portion of each tine extending from the main portion to the tip end of the tine, the main portion of each tine being elongated, the angled portion of each tine being elongated and being angled upwardly from the main portion, an angle between a longitudinal axis of the main portion and a longitudinal axis of the angled portion of each tine being between 10.0 degrees and 20.0 degrees, the main portion and the angled portion of each tine being straight, an end surface at the tip end and a bottom surface of the angled portion of each tine having an angle therebetween which is between 30.0 degrees and 40.0 degrees, the plurality of tines lying parallel to each other, each tine of the plurality of tines having a constant width between the mounting end and the tip end, each tine of the plurality of tines having a length between the mounting end and the tip end of between 4.5 inches and 5.5 inches;
a crossbar coupled to the plurality of tines, the crossbar being coupled to the mounting ends of the plurality of tines; and
a connection member coupled to the crossbar opposite the plurality of tines, the connection member being coupled to handle at the second end, the connection member comprising an elongated body with a tapered tip portion distal to the crossbar, the connection member being received into the elongated body through the second end, the connection member being coupled to the handle via a friction fit; and
a support ring coupled to the handle at the second end section, the support ring extending around and binding the handle to reinforce the handle.
